(19) United States
(12) Patent Application Publication
(10) Pub. No.: US 2005/0072553 A1
(43) Pub. Date: Apr. 7, 2005

(54) Gen set with external oil filter and pump

(76) Inventors: Robert Tigner, Arlington, TX (US); Keiv Brummett, Atoka, OK (US)

Correspondence Address: Attention: James E. Bradley;BRACEWELL & PATTERSON, L.L.P., P.O. Box 61389, Houston, TX, 77208-1389, US

(21) Appl. No.: 10/786,437

(22) Filed: Feb. 25, 2004

Related U.S. Application Data
(63) Continuation-in-part of application No. 10/680,309, filed on Oct. 7, 2003.

(51) Int. Cl. B60K 1/00; B60H 1/32; G05D 1/00; B64C 13/18; B60H 3/00; B61D 27/00; F25B 29/00

(52) U.S. Cl. 165/42; 62/244; 180/65.1; 318/587; 165/61

(57) ABSTRACT

A heating and air-conditioning system allows heating and cooling of a vehicle while the primary engine of the vehicle not operating. The auxiliary engine has an electrical generating device for generating electricity. A radiator is connected to the auxiliary engine for receiving engine coolant. A heater element is in communication with the radiator for receiving part of the coolant. A fan powered by the electrical generating device discharges air through the heater element and into the vehicle. The auxiliary engine also powers an air-conditioning unit for supplying cool air. An electrical motor drives a pump for pumping an engine lubricant to and from the auxiliary engine. An oil filter treats the lubricant.

### RELATED APPLICATIONS

This continuation-in-part patent application claims the benefit of co-pending, non-provisional patent application U.S. Ser. No. 10/680,309, filed on Oct. 7, 2003, which is hereby incorporated by reference in its entirety.

### BACKGROUND OF THE INVENTION

1. Field of the Invention

This invention relates in general to heating and cooling systems for vehicles, and in particular to a system utilizing an auxiliary engine.

2. Background of the Invention

Large tractor trucks typically have an air-conditioning system similar to automobiles. The truck engine drives a compressor that compresses refrigerant and delivers it to a condenser. The condenser converts the hot gaseous refrigerant to a liquid refrigerant. The refrigerant flows to an evaporator where it undergoes a pressure drop, converting the refrigerant to a cold gas. An interior fan flows air through the evaporator into the interior of the vehicle. The condenser is cooled by the main engine fan, which also flows air through the engine radiator.

For heating, a heater coil or element is mounted in the vehicle in communication with the radiator via hoses. A portion of the hot engine coolant flows through the heater coil. The interior fan flows air through the heater coil to heat the interior of the vehicle.

Many large trucks have sleeper compartments attached to the cab for allowing the driver to rest. In most cases, for heating and cooling, the operator continues to operate the main truck engine at idle while he is sleeping in order to run the air-conditioner or heater. The main engine generates far more power than needed for heating and cooling, consequently considerable fuel is consumed while the driver is resting.

Generators have been mounted to large trucks for generating 110 volt AC power. An auxiliary engine, normally diesel, is located in a compartment along with a generator. In these cases, a separate 110 volt air-conditioning unit mounts to the sleeper compartment or cab. The air-conditioning unit has an electrical motor that drives the compressor and the fan. For heat, an electrical resistance element may be employed, or the air-conditioner may be operated as a heat pump. Heating by a 110 volt air conditioner unit, however, consumes a considerable amount of power.

Another approach for heating and cooling while the truck is stopped is to utilize a 110 volt air conditioning unit and a power cord that extends to a power service receptacle at a rest stop. Many rest stops, however, do not have such provisions for connecting a vehicle to electrical power.

Other vehicles that have a need for air-conditioning and heating may not have a primary engine. These vehicles include recreational trailers and horse trailers. Generally, owners of trailers rely on being able to connect a power cord to a power receptacle. Heating and cooling is handled by a conventional 110 volt air conditioner mounted to the trailer.

### SUMMARY OF THE INVENTION

In this invention, an auxiliary engine is mounted in a housing, which in turn is mounted to the vehicle, whether it is a truck or trailer. The auxiliary engine has an electrical generating device that generates electricity. The generating device may be an alternating current generator. The generating device could also be a conventional DC alternator. The auxiliary engine is liquid cooled and has a radiator for receiving engine coolant flowing from the auxiliary engine. A heater coil or element is in fluid communication with the radiator for receiving at least part of the engine coolant flowing from the auxiliary engine. A fan causes flow through the heater element into the interior of the vehicle, the fan being powered by the electrical generating device.

For cooling, a compressor, condenser, and evaporator are utilized. The compressor is powered by the auxiliary engine, either directly or by an electrical motor that receives its power from the generating device. The evaporator is mounted adjacent the heater element so that air from the fan flows through the evaporator into the interior of the vehicle. Ducts extend directly from the auxiliary heating and air-conditioning system into the interior of the vehicle for supplying and returning conditioned air. The auxiliary unit is readily mounted to the truck.

The DC alternator supplies electricity to a pump motor that drives an oil or lubricant pump. The oil pump circulates engine oil or lubricant between the auxiliary engine and an oil filter. The oil filter helps to remove particles from the engine lubricant. Cleansing the oil lubricant prolongs the period of time between necessary oil changes for the auxiliary engine.

A mounting skid assembly supports multiple components within the housing. By mounting multiple components to the common mounting skid, the multiple components can be assembled relative to each other prior to installation within the housing. Further, when maintenance of any of the multiple components is required, the components are easily removed from within the housing by disconnecting the skid from the housing rather than each individual component.

### BRIEF DESCRIPTION OF THE DRAWINGS

FIG. 1 comprises a schematic view of a vehicle auxiliary power generating assembly constructed in accordance with this invention.

FIG. 2 comprises a schematic view of an alternative embodiment of the auxiliary power generating assembly of FIG. 1, but shown powering an auxiliary heating and air-conditioning system.

FIG. 3 is a perspective view of part of the auxiliary power generating assembly of FIG. 1 shown in a housing.

FIG. 4 is a bottom plan view of the skid for mounting the portion of the auxiliary power generating assembly shown in FIG. 3 within the housing.

### DETAILED DESCRIPTION OF THE PREFERRED EMBODIMENT

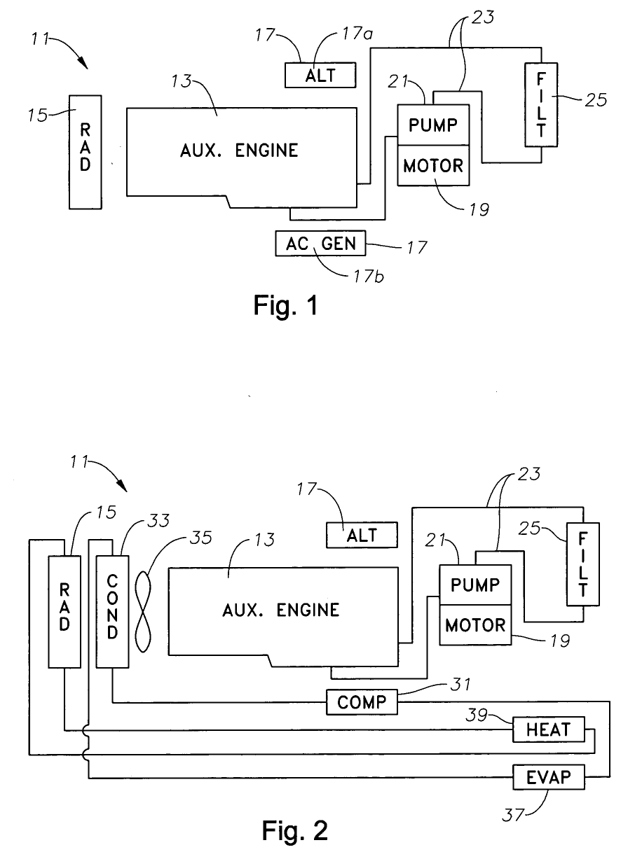

Referring to FIGS. 1 and 2, an auxiliary power unit 11 supplies an alternate source of power for a vehicle, typically a truck or a trailer, so that the main engine of the vehicle is not used when the vehicle is not being driven. Auxiliary power unit 11 is capable of being configured for providing alternating current (AC) electrical power in the configuration shown in FIG. 1. The AC electricity can then be used to supply power to an auxiliary heating and air conditioning unit (not shown), or any other electrical devices that are capable of running on 110 volt, AC electricity. Auxiliary power unit 11 is also capable of being configured for driving an auxiliary heating and air conditioning system in the configuration shown in FIG. 2. Accordingly, without reference to a particular configuration, the term auxiliary power unit 11 is intended to comprise a unit for either generating electricity as shown in FIG. 1, or for driving an auxiliary heating and air conditioning system, as shown in FIG. 2, or both.

Referring to FIG. 1, auxiliary power unit 11 includes an auxiliary engine 13. Auxiliary engine 13 is preferably a small diesel engine. In one embodiment, auxiliary engine 13 has a single cylinder that is horizontally oriented. Auxiliary engine 13 preferably receives its fuel from a fuel tank (not shown). In the preferred embodiment auxiliary engine 13 is liquid cooled. An auxiliary radiator 15 is fluidly connected to auxiliary engine 13 for cooling a coolant for maintaining acceptable operating temperatures within auxiliary engine 13. Preferably, an engine fan 35 (not shown in FIG. 1) blows air over radiator 15 for proper cooling of the coolant passing therein.

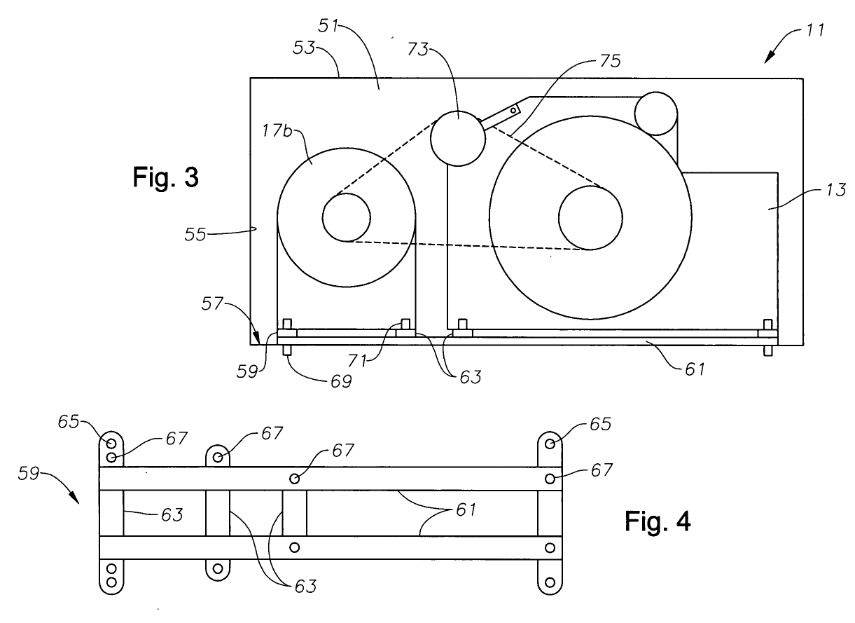

Auxiliary engine 13 drives an auxiliary electricity generating device 17. In the embodiment shown in FIG. 1, electricity generating device 17 is capable of being an alternator 17a or an alternating current (AC) generator 17b. Alternator 17a is preferably mechanically coupled to auxiliary engine 13. Alternator 17a preferably converts mechanical energy from auxiliary engine 13 into 12-volt direct current (DC) electricity. Alternator 17a can advantageously provide electrical power to operate other equipment devices in auxiliary power unit 11. AC generator 17b can also be mechanically coupled to auxiliary engine 13. Auxiliary engine 13 preferably drives AC generator 17b through a belt 75 (FIG. 3) and pulley 73 (FIG. 3) assembly. AC generator 17b provides electrical power to a separately housed heating and air-conditioner unit (not shown) for the vehicle, or to any other electrical device that plugs into and operates on 110-volt AC current electricity. Typically, the separately housed heating and air-conditioning unit is mounted to a floor or a wall of the sleeping compartment of the truck, or to the trailer being pulled by the truck, or mounted to auxiliary power unit 11.

Auxiliary engine 13 supplies power to a motor 19 and a pump 21. Motor 19 is preferably a 12-volt motor that receives DC electricity from alternator 17a. Accordingly, in the preferred embodiment, auxiliary engine 13 powers motor 19 through alternator 17a. Motor 19 drives pump 21 to supply oil, or any other acceptable engine lubricant, to auxiliary engine 13. Pump 21 is in fluid communication with auxiliary engine 13 through fluid lines 23. A filter 23 is fluidly connected to fluid lines 25 so that filter 23 is in fluid communication with auxiliary engine 13 and pump 21. Filter 23 cleanses the oil or lubricant pumped into auxiliary engine 13 with pump 21. Using filter 23 allows the operator to operate auxiliary engine 13 for longer periods of time between necessary oil changes compared to previous auxiliary engines operating without a pump and oil filter.

Referring to FIG. 2, auxiliary power unit 11 includes but is not limited to the same configuration as that shown in FIG. 1, except an auxiliary compressor 31 is mechanically coupled with auxiliary engine 13 instead of AC generator 17b. Alternately, unit 11 could have both a compressor 13 and generator 17b. Auxiliary compressor 31 can be directly coupled to the drive shaft of auxiliary engine 13, or preferably a belt and pulley assembly can be used in a manner similar to the configuration shown in FIGS. 1 and 3.

An auxiliary condenser 33 is preferably positioned adjacent auxiliary radiator 15 so that radiator 15 and condenser 33 are parallel to each other and separated to receive air flow from an auxiliary fan 35. Fan 35 is preferably driven by an electrical motor (not shown), which in turn is also powered by alternator 17a or from the truck batteries if no alternator is used. Auxiliary radiator 57 is in fluid communication, typically through hoses, with auxiliary engine 13 for receiving and cooling the engine coolant.

Condenser 33 is connected by lines to compressor 31 for condensing hot gaseous refrigerant into a liquid. Condenser 33 also has an output line that leads to an evaporator 37. Evaporator 37 includes an expansion valve that reduces the pressure of the refrigerant, causing it to convert to a cold gas. The refrigerant returns from evaporator 37 by a line to compressor 31. An auxiliary heater coil or element 39 is also associated with auxiliary power unit 11. Auxiliary heater 39 is connected by hoses to radiator 15 for receiving a portion of the hot engine coolant running through radiator 15. Valves (not shown) selectively close the coolant flow through heater 39 while it is not operating. In a manner known in the art, an auxiliary interior circulation fan (not shown) circulates air through heater 39, evaporator 37 and the interior cab and sleeping compartment of the vehicle. The auxiliary interior circulation fan (not shown) is preferable driven by an electrical motor powered by alternator 17. Evaporator 37 is preferably mounted adjacent heater element 39 so that air moved by fan 35 flows through evaporator 37 into the interior of the vehicle

Referring to FIG. 3, a portion of auxiliary power unit 11 according to the configuration illustrated in FIG. 1 is shown within a housing 51. Housing 51 is adapted in a manner known in the art for attachment to the vehicle. For a large truck, like an eighteen-wheeler, housing 51 is preferably mounted adjacent a step box of the vehicle. Housing 51 preferably encloses auxiliary engine 13, alternator 17a (not shown in FIG. 3), and AC generator 17b. Housing 51 has a longitudinal side 53 defining the length of housing 51, and a lateral side 55 defining the width of housing 51. Preferably, housing 51 is substantially rectangular in shape, with a plurality of longitudinal sides 53 with a plurality of lateral sides 55 extending therebetween. A lower surface 57 is preferably formed within housing 51 for supporting auxiliary engine 13, and AC generator 17b. In the embodiment shown in FIG. 3, lower surface 57 is a base plate of housing 51, but it should be readily apparent to those skilled in the art that lower surface could also be a lower portion of one of longitudinal or lateral sides 53, 55. A mounting skid 59 fixedly connects auxiliary engine 13 and AC generator 17b to lower surface 57 of housing 51.

Referring to FIG. 4, mounting skid 59 has a longitudinal member 61 that, when connected to lower surface 57, extends between lateral sides 55, substantially parallel with lower surface 57 and longitudinal side 53. A lateral member 63 extends substantially perpendicular to longitudinal member 61. In the preferred embodiment, there is a pair of longitudinal members 61 spaced apart and extending substantially parallel to each other. Preferably, there is a plurality of lateral members 63 extend extending between longitudinal members 61. In the preferred embodiment, a plurality of fastener bores 65 are formed through laterally outer portions of at least some of lateral members 63. A plurality of coupler bores 67 are formed in lateral members 63 at laterally inward positions relative to fastener bores 65.

As shown in FIGS. 3 and 4, each fastener bore 65 receives a fastener 69, typically a threaded fastener or screw, for connecting mounting skid 59 to lower surface 57 of housing 51. Each coupler bore 67 preferably receives a coupler 71, typically a threaded fastener or screw, for connecting auxiliary engine 13 and AC generator 17b to mounting skid 59. Having fastener bores 65 laterally outward relative to coupler bores 67 allows for the removal of mounting skid 59 with auxiliary engine 13 and AC generator 17b still attached as one unit rather than having to remove each part individually.

As best illustrated in FIG. 3, AC generator 17b and auxiliary engine 13 are separate, spaced-apart units that can be replaced without removing the other unit as desired. A pulley 73 and belt 75 assembly mechanically connects auxiliary engine 13 and AC generator 17b for conveyance of rotational energy from engine 13 to AC generator 17b for the generation of AC electricity.

As will be appreciated by those skilled in the art, the size of housing 51 can be altered from that shown in FIG. 3 for housing motor 19, pump 21 and filter 23 as desired. Filter 23 can also be located outside of housing 51 for easier accessibility by an operator for filter changes.

During operation, while driving the vehicle, the operator would normally utilize only the main heating and cooling system. When the truck or vehicle is stopped and the main engine is turned off, the operator starts auxiliary engine 13 if heating or cooling is desired. If the weather is cold, the operator can heat the interior of the sleeping compartment and the cab by opening valves to allow auxiliary engine coolant to flow from auxiliary radiator 15 through heater 39. Auxiliary fan 35 causes air to flow through heater 39 and out a supply duct. The air returns by a return duct. If the weather is hot, the operator turns on the air conditioning portion of unit 11. Auxiliary engine 13 directly drives compressor 31, which supplies pressurized gaseous refrigerant to condenser 33. The refrigerant flows to evaporator 37, where it is expanded and flows back to compressor 31. Fan 35 discharges air through evaporator 37 and into the interior of vehicle. The air circulates back through the return duct.

In the situation with an electrical auxiliary heating and air-conditioning unit, the embodiment shown in FIG. 1 supplies 110-volt, AC electricity to the auxiliary heating and air-conditioning unit when the vehicle is stopped and the main engine is turned off. In this embodiment, the operator turns on auxiliary engine 13 after stopping the vehicle. Engine 13 drives AC generator 17b which then supplies the 110-volt, AC electricity to the auxiliary heating and air-conditioning unit. Alternatively, the operator can plug another electrical device into AC generator 17b for 100-volt, AC electricity.

In both embodiments, alternator 17a provides DC electricity to motor 19. Motor 19 drives pump 21 to supply the engine lubricant to auxiliary engine 13 through fluid lines 25. Oil filter 23 removes contaminants from the engine lubricant in fluid lines 25 to help extend the operating time between oil changes for auxiliary engine 13.

While the invention has been shown in only some of its forms, it should be apparent to those skilled in the art that it is not so limited but is susceptible to various changes without departing from the scope of the invention. For example, AC generator 17b can be replaced with compressor 31 in FIG. 3 so that belt 75 and pulley 73 are connecting auxiliary engine 13 on mounting skid 59 to compressor 31.

1. A vehicle auxiliary power generating apparatus, comprising:
a housing adapted to be mounted to an exterior portion of a vehicle;
an auxiliary engine located in the housing;
an electrical generating device coupled to the auxiliary engine for generating electricity;
an electrically driven pump for providing a lubricant to the auxiliary engine, the pump being mounted exterior of the auxiliary engine and powered by the electrical generating device; and
a lubricant filter fluidly located between the pump and the auxiliary engine for treating the lubricant.

2. The apparatus according to claim 1, further comprising a motor that is powered by the electrical generating device and is coupled to the pump for driving the pump.

3. The apparatus according to claim 1, wherein the auxiliary engine and electrical generating device are mounted to a mounting skid that is removable from the housing.

4. The apparatus according to claim 1, further comprising a removable mounting skid that releasably connects to a lower surface of the housing and supports the auxiliary engine.

5. The apparatus according to claim 1, wherein the electrical generating device generates DC electricity; and further comprising:
a motor that receives DC electricity from the electrical generating device and is coupled to the pump for driving the pump.

6. The apparatus according to claim 1, wherein the electrical generating device further comprises:
an alternator for generating DC electricity; and
an AC generator for generating AC electricity.

7. The apparatus according to claim 6, further comprising a motor that receives DC electricity from the alternator and is coupled to the pump for driving the pump

8. The apparatus according to claim 1, further comprising:
a compressor for compressing gaseous refrigerant;
a condenser in communication with the compressor for condensing the compressed refrigerant into a liquid refrigerant; and
an evaporator in fluid communication with the condenser for converting the liquid refrigerant into gaseous refrigerant, the evaporator being mounted adjacent the heater element so that air moved by the fan flows through the evaporator into the interior of the vehicle.

9. The apparatus according to claim 8, wherein the compressor is mechanically driven by the auxiliary engine.

10. A vehicle auxiliary power generating apparatus, comprising:
a housing adapted to be mounted to an exterior portion of a vehicle;
an auxiliary engine supported by the mounting skid within the housing;
a DC electrical generating device coupled to the auxiliary engine for generating DC electricity;
a motor mounted exterior of the auxiliary engine that receives electricity from the DC electrical generating device;
a pump for providing a lubricant to the auxiliary engine, the pump being driven by the motor; and
a lubricant filter fluidly located between the pump and the auxiliary engine for treating the lubricant.

11. The apparatus according to claim 10, further comprising an AC generator for generating AC electricity that is mechanically coupled to the auxiliary engine.

12. The apparatus according to claim 10, further comprising:
a compressor for compressing gaseous refrigerant that is mechanically driven by the auxiliary engine;
a condenser in communication with the compressor for condensing the compressed refrigerant into a liquid refrigerant; and
an evaporator in fluid communication with the condenser for converting the liquid refrigerant into gaseous refrigerant, the evaporator being mounted adjacent the heater element so that air moved by the fan flows through the evaporator into the interior of the vehicle.

13. A vehicle auxiliary power generating apparatus, comprising:
a housing adapted to be mounted to an exterior portion of a vehicle;
an auxiliary engine located in the housing;
a longitudinal member that extends substantially parallel to the lower surface of the housing when mounted within the housing;
a plurality lateral cross-members connected to the longitudinal member;
a plurality of fasteners extending through laterally outward portions of the lateral cross-members and for connecting the mounting skid to the housing; and
a plurality of threaded couplers extending through portions of the mounting skid that are laterally inward from the plurality of fasteners for connecting the auxiliary engine to the mounting skid.

14. The apparatus according to claim 13, wherein there are two longitudinal members that are spaced apart and substantially parallel to each other.

15. The apparatus according to claim 14, wherein the two longitudinal members are connected by the lateral cross-members.

16. The apparatus according to claim 13, further comprising an AC electrical generating device mounted to the mounting skid adjacent the auxiliary engine, and the plurality of threaded couplers also extend through portions of the mounting skid laterally inward of the plurality of fasteners for connecting the electrical generating device to the mounting skid.

17. The apparatus according to claim 13, further comprising:
a DC electrical generating device coupled to the auxiliary engine for generating DC electricity;
a motor mounted exterior of the auxiliary engine that receives electricity from the DC electrical generating device;
a pump for providing a lubricant to the auxiliary engine, the pump being driven by the motor; and
a lubricant filter fluidly located between the pump and the auxiliary engine for treating the lubricant.

18. The apparatus according to claim 13, further comprising:
a compressor for compressing gaseous refrigerant that is mechanically driven by the auxiliary engine;
a condenser in communication with the compressor for condensing the compressed refrigerant into a liquid refrigerant; and
an evaporator in fluid communication with the condenser for converting the liquid refrigerant into gaseous refrigerant, the evaporator being mounted adjacent the heater element so that air moved by the fan flows through the evaporator into the interior of the vehicle.
